(19) United States
(12) Patent Application Publication
(10) Pub. No.: US 2021/0097774 A1
(43) Pub. Date: Apr. 1, 2021

(54) MATERIAL REPLACEMENT METHOD, MATERIAL REPLACEMENT SYSTEM, AND NON-TRANSITORY COMPUTER READABLE STORAGE MEDIUM

(71) Applicant: INSTITUTE FOR INFORMATION INDUSTRY, Taipei (TW)

(72) Inventors: Shang-Ming WANG, Taipei (TW); Chi-Hsien LIU, Taipei (TW)

(21) Appl. No.: 16/669,532

(22) Filed: Oct. 31, 2019

(30) Foreign Application Priority Data
Oct. 1, 2019 (TW) 108135587

(51) Int. Cl. G06T 19/20; G06T 19/00; G06T 17/10

(52) U.S. Cl. CPC G06T 19/20; G06T 17/10; G06T 19/006

(57) ABSTRACT

A material replacement method includes: generating a plurality of first areas according to a plurality of first feature points of a mapped object by a processor, to establish a first planar model corresponding to the mapped object; generating a plurality of second areas according to a plurality of second feature points of a mapping object by the processor, to establish a second planar model corresponding to the mapping object; respectively performing an alignment process to the second areas of the second planar model based on the first areas of the first planar model by the processor; and respectively replacing the first areas by the adjusted second areas by the processor, to replace the mapped object by the mapping object and establish a stereoscopic model of the mapping object.

### RELATED APPLICATIONS

This application claims priority to Taiwanese Application Serial Number 108135587, filed Oct. 1, 2019, which is herein incorporated by reference.

### BACKGROUND

### Technical Field

The present disclosure relates to a material replacement technology. More particularly, the present disclosure relates to a material replacement method, a material replacement system, and a non-transitory computer readable storage medium.

### Description of Related Art

With development of the computer technology, the model texture technology has been applied to various fields. The fields are, for example, two-dimension environments or three-dimension environments. In some related approaches, a mapping object is directly and entirely mapped onto a mapped object. These approaches introduce deformations into a model texture result.

### SUMMARY

Some aspects of the present disclosure are to provide a material replacement method. The material replacement method includes: generating a plurality of first areas according to a plurality of first feature points of a mapped object by a processor, to establish a first planar model corresponding to the mapped object; generating a plurality of second areas according to a plurality of second feature points of a mapping object by the processor, to establish a second planar model corresponding to the mapping object; respectively performing an alignment process to the second areas of the second planar model based on the first areas of the first planar model by the processor; and respectively replacing the first areas by the adjusted second areas by the processor, to replace the mapped object by the mapping object and establish a stereoscopic model of the mapping object.

Some aspects of the present disclosure are to provide a material replacement system. The material replacement system includes a memory, a processor, and a display device. The memory is configured to store one or more programs. The one or more programs include instructions. The processor is configured to execute the instructions to execute following steps: generating, by a processor, a plurality of first areas according to a plurality of first feature points of a mapped object, to establish a first planar model corresponding to the mapped object; generating, by the processor, a plurality of second areas according to a plurality of second feature points of a mapping object, to establish a second planar model corresponding to the mapping object; respectively performing, by the processor, an alignment process to the second areas of the second planar model based on the first areas of the first planar model; and respectively replacing, by the processor, the first areas by the adjusted second areas, to replace the mapped object by the mapping object and establish a stereoscopic model of the mapping object. The display device is configured to display the stereoscopic model.

Some aspects of the present disclosure are to provide a non-transitory computer readable storage medium storing one or more programs. The one or more programs include instructions and a processor is configured to execute the instructions. When the processor executes the instructions, the processor executes following steps: generating a plurality of first areas according to a plurality of first feature points of a mapped object, to establish a first planar model corresponding to the mapped object; generating a plurality of second areas according to a plurality of second feature points of a mapping object, to establish a second planar model corresponding to the mapping object; respectively performing an alignment process to the second areas of the second planar model based on the first areas of the first planar model; and respectively replacing the first areas by the adjusted second areas, to replace the mapped object by the mapping object and establish a stereoscopic model of the mapping object.

As described above, the material replacement method, the material replacement system, and the non-transitory computer readable storage medium of the present disclosure can reduce the deformation degree of the replacement result by performing a local processing to the mapping object.

### BRIEF DESCRIPTION OF THE DRAWINGS

FIG. 1 is a schematic diagram of a material replacement system according to some embodiments of the present disclosure.

FIG. 2 is a flow diagram illustrating a material replacement method according to some embodiments of the present disclosure.

FIG. 3 is a detailed flow diagram of FIG. 2 according to some embodiments of the present disclosure.

FIG. 4 is a schematic diagram of an operation in FIG. 3 according to some embodiments of the present disclosure.

FIG. 5 is a schematic diagram of an operation in FIG. 3 according to some embodiments of the present disclosure.

FIG. 6 is a schematic diagram of an operation in FIG. 3 according to some embodiments of the present disclosure.

FIG. 7 is a schematic diagram of an operation in FIG. 3 according to some embodiments of the present disclosure.

FIG. 8 is a schematic diagram of an operation in FIG. 3 according to some embodiments of the present disclosure.

FIG. 9 is a schematic diagram of an operation in FIG. 3 according to some embodiments of the present disclosure.

FIG. 10 is a schematic diagram of an operation in FIG. 3 according to some embodiments of the present disclosure.

FIG. 11 is a schematic diagram of two operations in FIG. 3 according to some embodiments of the present disclosure.

FIG. 12 is a schematic diagram of an operation in FIG. 3 according to some embodiments of the present disclosure.

FIG. 13 is a schematic diagram of a mapped object is replaced by a mapping object according to some embodiments of the present disclosure.

FIG. 14 is a schematic diagram of an operation in FIG. 3 according to some embodiments of the present disclosure.

### DETAILED DESCRIPTION

The following embodiments are disclosed with accompanying diagrams for detailed description. For illustration clarity, many details of practice are explained in the following descriptions. However, it should be understood that these details of practice do not intend to limit the present disclosure. That is, these details of practice are not necessary in parts of embodiments of the present embodiments. Furthermore, for simplifying the drawings, some of the conventional structures and elements are shown with schematic illustrations.

In the present disclosure, “connected” or “coupled” may be referred to “electrically connected” or “electrically coupled.” “Connected” or “coupled” may also be referred to operations or actions between two or more elements.

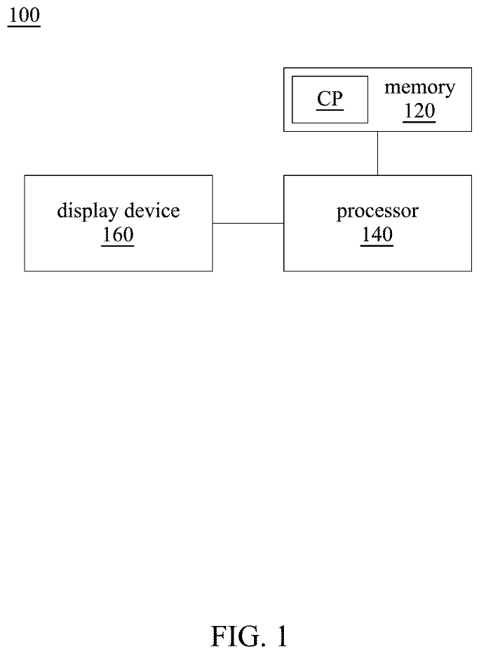

Reference is made to FIG. 1. FIG. 1 is a schematic diagram of a material replacement system 100 according to some embodiments of the present disclosure. As illustrated in FIG. 1, the material replacement system 100 includes a memory 120, a processor 140, and a display device 160. The processor 140 is coupled to the memory 120. The processor 140 is coupled to the display device 160.

In some embodiments, the memory 120 may be implemented by a non-transitory computer readable storage medium. The non-transitory computer readable storage medium is, for example, a ROM (read-only memory), a flash memory, a floppy disk, a hard disk, an optical disc, a flash disk, a flash drive, a tape, a database accessible from a network, or any storage medium with the same functionality that can be contemplated by persons of ordinary skill in the art to which this disclosure pertains. The memory 120 is configured to store one or more computer programs CP including a plurality of instructions. In some embodiments, the processor 140 may be implemented by a central processor or a microprocessor. In some embodiments, the display device 160 may be implemented by a display panel, a touch display panel, or a head mounted device (HMD).

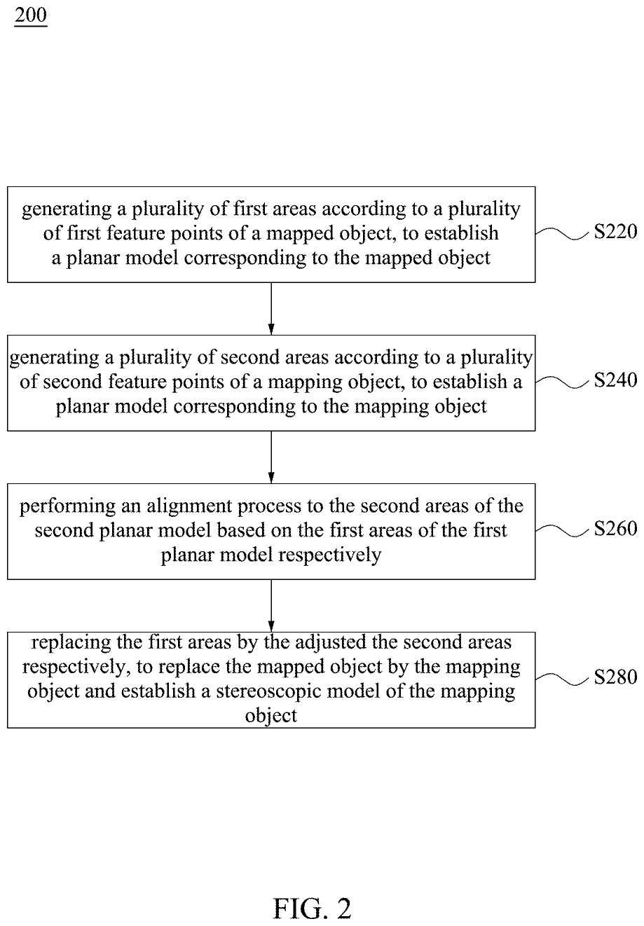

References are made to FIG. 1 and FIG. 2. FIG. 2 is a flow diagram illustrating a material replacement method 200 according to some embodiments of the present disclosure. When the computer program CP is executed by the processor 140, a computer, or one other electrical device, the material replacement method 200 is executed. As illustrated in FIG. 2, the material replacement method 200 includes an operation S220, an operation S240, an operation S260, and an operation S280. In some embodiments, the material replacement method 200 is applied to the material replacement system 100 in FIG. 1, but the present disclosure is not limited thereto. For ease of understanding, following paragraphs are discussed with FIG. 1.

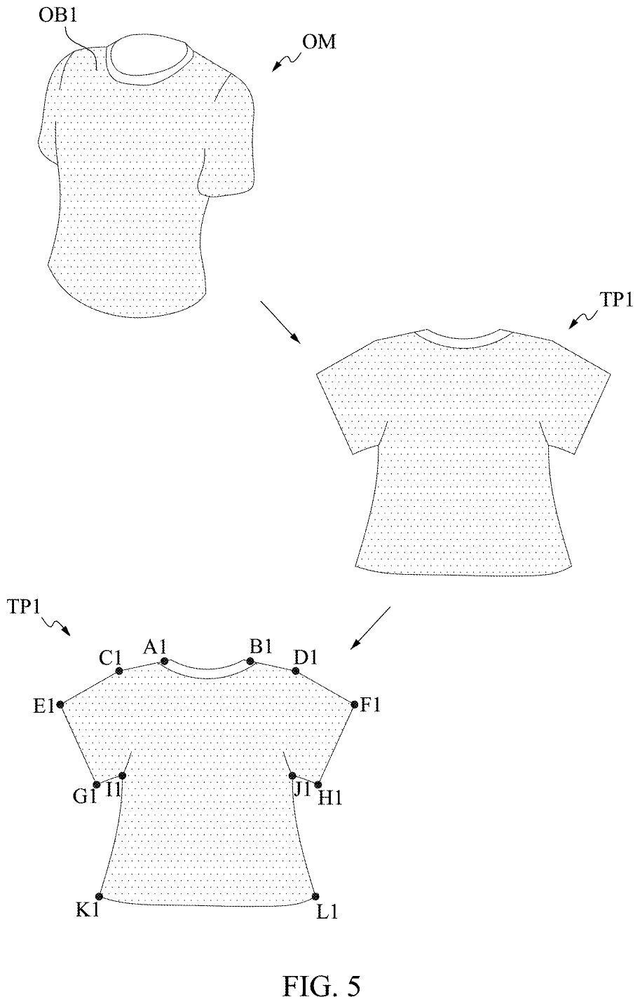

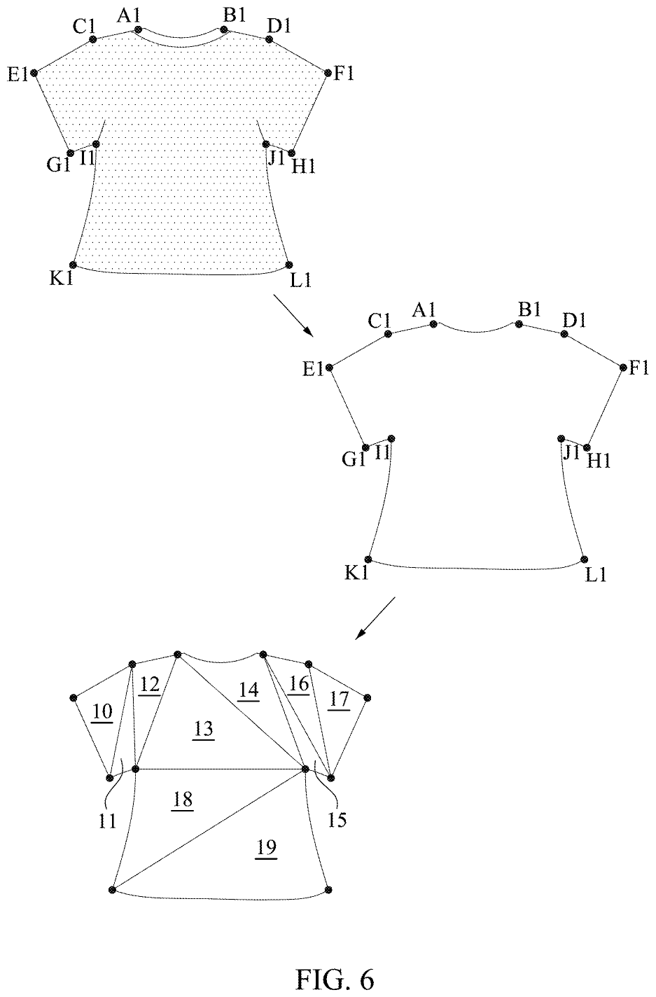

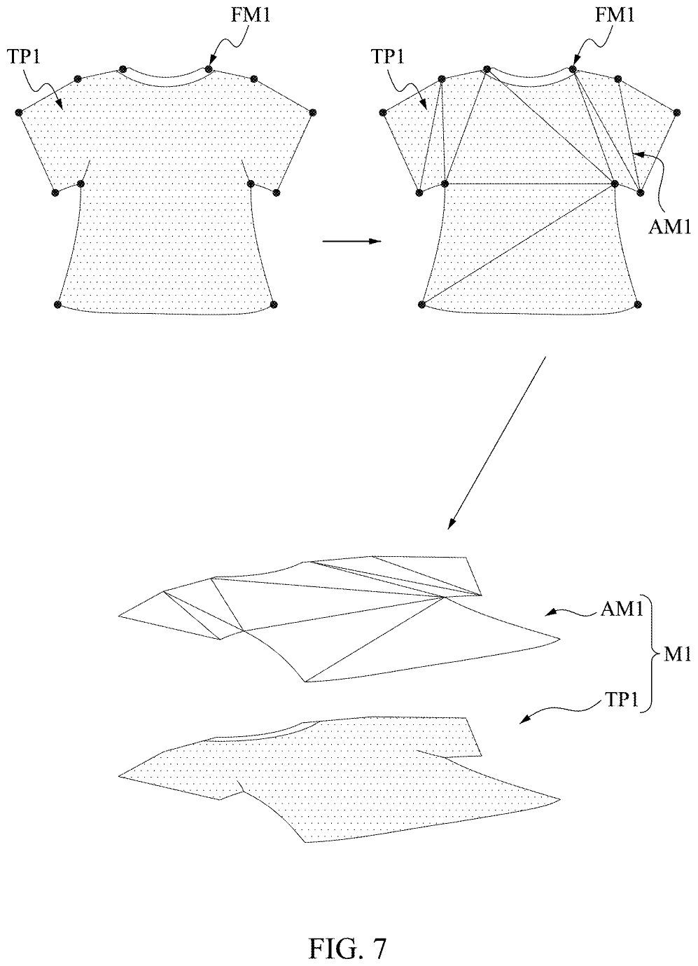

In the operation S220, the processor 140 generates a plurality of first areas (for example: a plurality of first areas 10-19 in FIG. 6) according to a plurality of feature points (for example: a plurality of feature points A1-L1 in FIG. 5) of a mapped object (for example: a mapped object OB1 in FIG. 5), to establish a planar model (for example: a planar model M1 in FIG. 7) corresponding to the mapped object in a three-dimension environment.

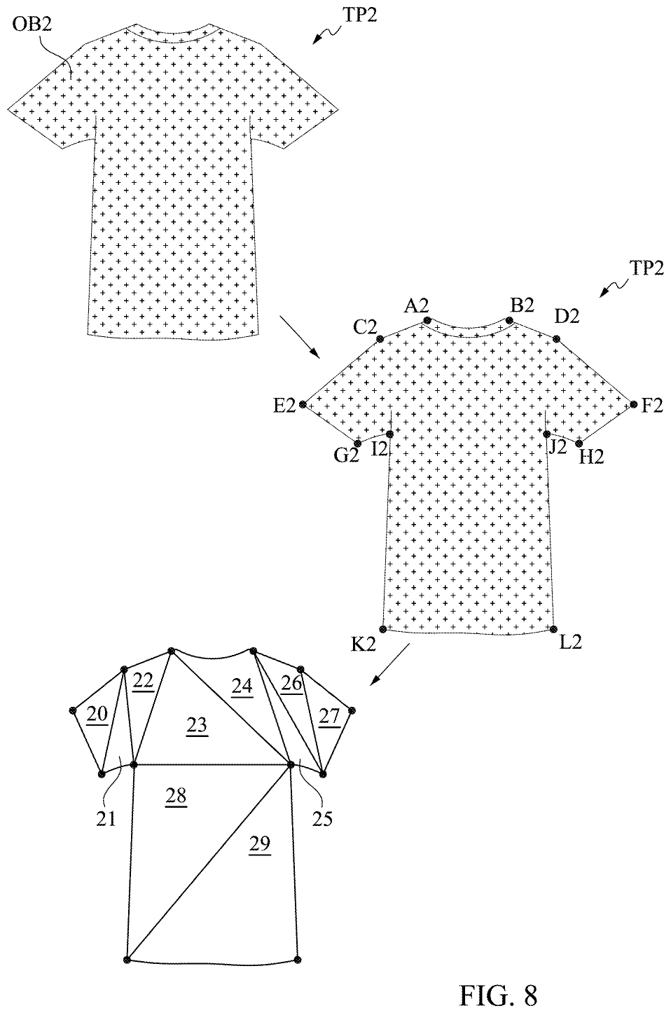

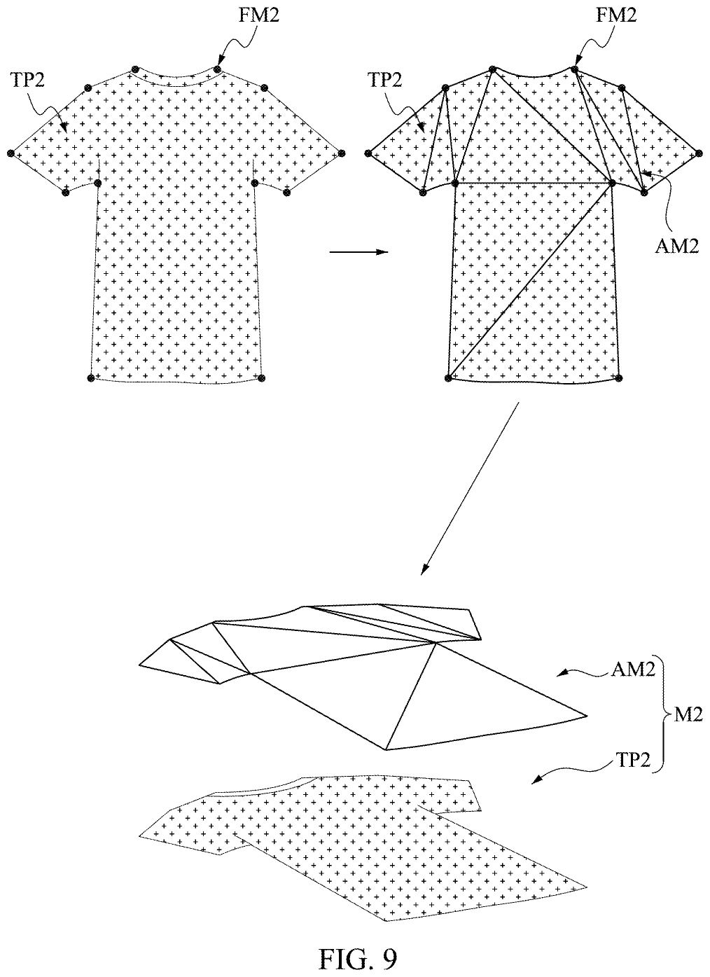

In the operation S240, the processor 140 generates a plurality of second areas (for example: a plurality of second areas 20-29 in FIG. 8) according to a plurality of feature points (for example: a plurality of feature points A2-L2 in FIG. 8) of a mapping object (for example: a mapping object OB2 in FIG. 8), to establish a planar model (for example: a planar model M2 in FIG. 9) corresponding to the mapping object in the three-dimension environment.

In the operation S260, the processor 140 performs an alignment process to the second areas (for example: the second areas 20-29 in FIG. 8) based on the first areas (for example: the first areas 10-19 in FIG. 6) respectively.

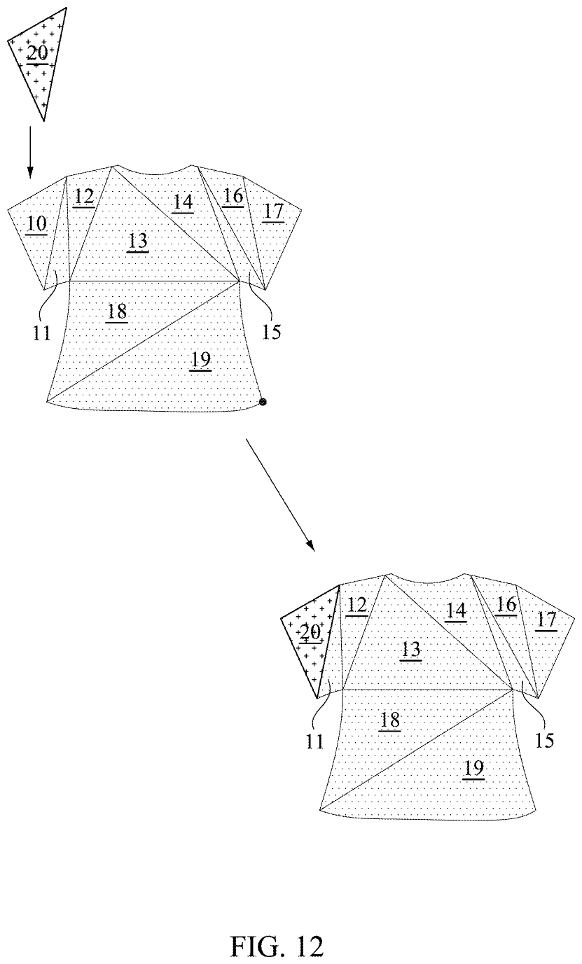

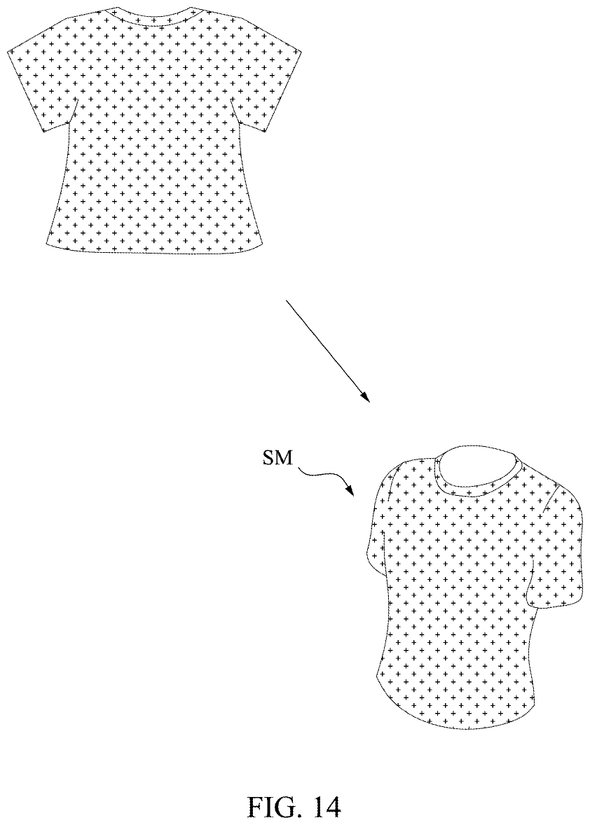

In the operation S280, the processor 140 replaces each of the first areas (for example: the first area 10 in FIG. 12) by the adjusted each of the second areas (for example: the second area 20 in FIG. 12) respectively, to replace the mapped object (for example: the mapped object OB1 in FIG. 5) by the mapping object (for example: the mapping object OB2 in FIG. 8) and establish a stereoscopic model (for example: a stereoscopic model SM in FIG. 14) of the mapping object (for example: the mapping object OB2 in FIG. 8).

In the material replacement method 200, the deformation degree can be reduced by local processing of the mapping object.

In addition, in some related approaches, a feature matching algorithm or an affine transformation algorithm is utilized to perform the material replacement. Calculation volumes in these approaches are enormous, so calculation speeds in these approaches are slow. In the material replacement method 200, a processing speed can be sped up by transferring the two-dimension picture to the three-dimension environment.

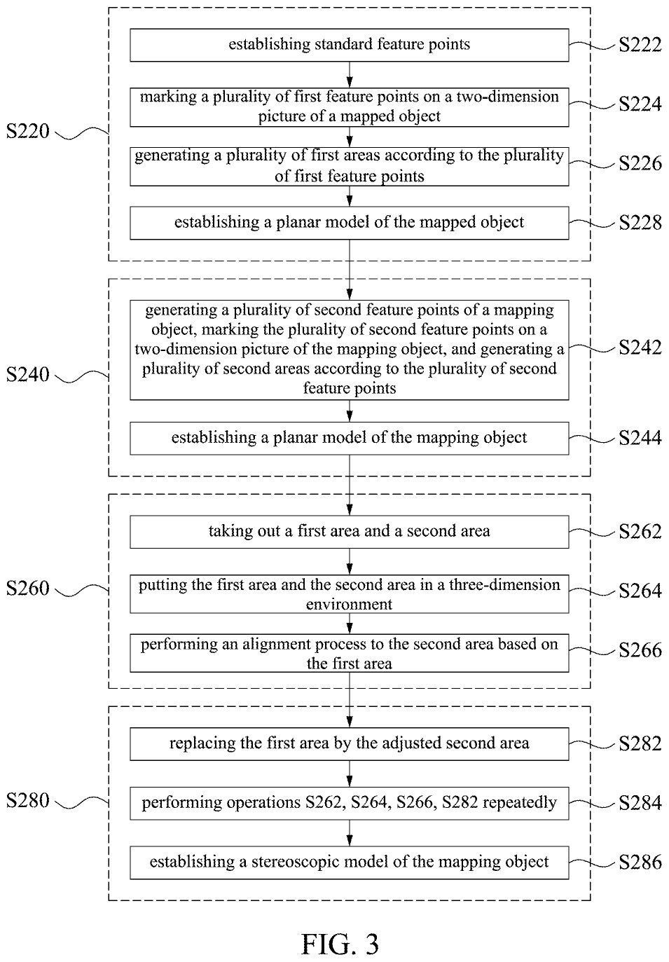

Reference is made to FIG. 3. FIG. 3 is a detailed flow diagram of FIG. 2 according to some embodiments of the present disclosure. In specific, the operation S220 further includes an operation S222, an operation S224, an operation S226, and an operation S228. The operation S240 further includes an operation S242 and an operation S244. The operation S260 further includes an operation S262, an operation S264, and an operation S266. The operation S280 further includes an operation S282, an operation S284, and an operation S286.

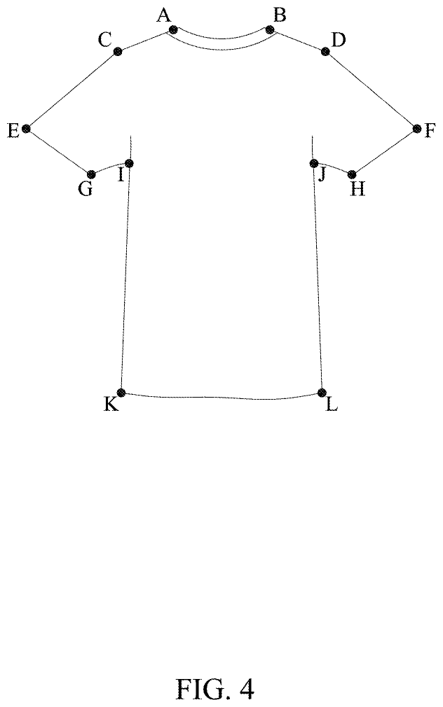

Reference is made to FIG. 4. FIG. 4 is a schematic diagram of the operation S222 in FIG. 3 according to some embodiments of the present disclosure. In the operation S222 in FIG. 3, the processor 140 establishes standard feature points A-L of a kind of object. As illustrated in FIG. 4, the kind of object is clothes, but the present disclosure is not limited thereto. Various kinds of object (for example: cups) are within scopes of the present disclosure. As illustrated in FIG. 4, the standard feature points A and B are neckline standard feature points. The standard feature points C and D are shoulder standard feature points. The standard feature points E and F are upped cuff standard feature points. The standard feature points G and H are lower cuff standard feature points. The standard feature points I and J are chest standard feature points. The standard feature points K and L are lower edge standard feature points. In some embodiments, a quantity and configurations of the standard feature points are related to a shape of the kind of object. For example, there are more feature points at corners of clothes.

Reference is made to FIG. 5. FIG. 5 is a schematic diagram of the operation S224 in FIG. 3 according to some embodiments of the present disclosure. In the operation S224 in FIG. 3, the processor 140 marks the feature points A1-L1 on a two-dimension picture TP1 of the mapped object OB1. As illustrated in FIG. 5, the processor 140 first takes out the two-dimension picture TP1 of the mapped object OB1 from an original stereoscopic model OM of the mapped object OB. Then, the processor 140 marks the feature points A1-L1 corresponding to the feature points A-L in FIG. 4 on the two-dimension picture TP1 of the mapped object OB1.

Reference is made to FIG. 6. FIG. 6 is a schematic diagram of the operation S226 in FIG. 3 according to some embodiments of the present disclosure. In the operation S226 in FIG. 3, the processor 140 generates the first areas 10-19 according to the feature points A1-L1. As illustrated in FIG. 6, the processor 140 first takes out the feature points A1-L1 of the mapped object OB1. Then, the processor 140 connects each N adjacent feature points of the feature points A1-L1 according to a partition rule, to generate the first areas 10-19, in which N is a positive integer equal to or greater than 3. As illustrated in FIG. 6, the partition rule is corresponding to a triangle rule. In other words, the processor 140 connects each 3 adjacent feature points of the feature points A1-L1, to generate the first areas 10-19 having triangle shapes. The shapes of the first areas 10-19 may be not all the same. In some other embodiments, the partition rule is corresponding to a quadrilateral rule or other rules of other shapes. Various suitable shapes are within scopes of the present disclosure.

Reference is made to FIG. 7. FIG. 7 is a schematic diagram of the operation S228 in FIG. 3 according to some embodiments of the present disclosure. In the operation S228 in FIG. 3, the processor 140 establishes a planar model M1 of the mapped object OB1. As illustrated in FIG. 7, the processor 140 first imports the two-dimension picture TP1 of the mapped object OB1 and feature information FM1 related about the feature points A1-L1 in FIG. 6. Then, area information AM1 related about the feature points A1-L1 in FIG. 6 is imported. Then, the planar model M1 of the mapped object OB1 is established in the three-dimension environment. The planar model M1 includes the two-dimension picture TP1 of the mapped object OB1 and the area information AM1 of the mapped object OB1.

Reference is made to FIG. 8. FIG. 8 is a schematic diagram of the operation S242 in FIG. 3 according to some embodiments of the present disclosure. In the operation S242 in FIG. 3, the processor 140 generates the feature points A2-L2 of the mapping object OB2, marks the feature points A2-L2 on a two-dimension picture TP2 of the mapping object OB2, and generates the second areas 20-29 according to the feature points A2-L2. As illustrated in FIG. 8, the processor 140 first takes out the two-dimension picture TP2 of the mapping object OB2. Then, the processor 140 marks the feature points A2-L2 corresponding to the feature points A-L in FIG. 4 on the two-dimension picture TP2 of the mapping object OB2. Then, the processor 140 connects each N adjacent feature points of the feature points A2-L2 according to the same partition rule, to generate the second areas 20-29. Shapes of the second areas 20-29 may be not all the same. Due to the same partition rule, a quantity and positions of the second areas 20-29 are corresponding to a quantity and positions of the first areas 10-19 in FIG. 6.

In some embodiments, the shapes of the first areas 10-19 in FIG. 6 or the shapes of the second areas 20-29 in FIG. 8 may be set by an operation of a user according to a need of the user. For example, if the user would like to set the aforementioned shapes, the user can operate an electrical device or modify the computer programs CP in FIG. 1. Then, the processor 140 receives one or more corresponding setting commands, and sets the shapes of the first areas 10-19 in FIG. 6 or the shapes of the second areas 20-29 in FIG. 8 according to the one or more corresponding setting commands.

Reference is made to FIG. 9. FIG. 9 is a schematic diagram of the operation S244 in FIG. 3 according to some embodiments of the present disclosure. In the operation S244 in FIG. 3, the processor 140 establishes a planar model M2 of the mapping object OB2. As illustrated in FIG. 9, the processor 140 first imports the two-dimension picture TP2 of the mapping object OB2 and feature information FM2 related about the feature points A2-L2 in FIG. 8. Then, area information AM2 related about the feature points A2-L2 in FIG. 8 is imported. Then, the planar model M2 of the mapping object OB2 is established in the three-dimension environment. The planar model M2 includes the two-dimension picture TP2 of the mapping object OB2 and the area information AM2 of the mapping object OB2.

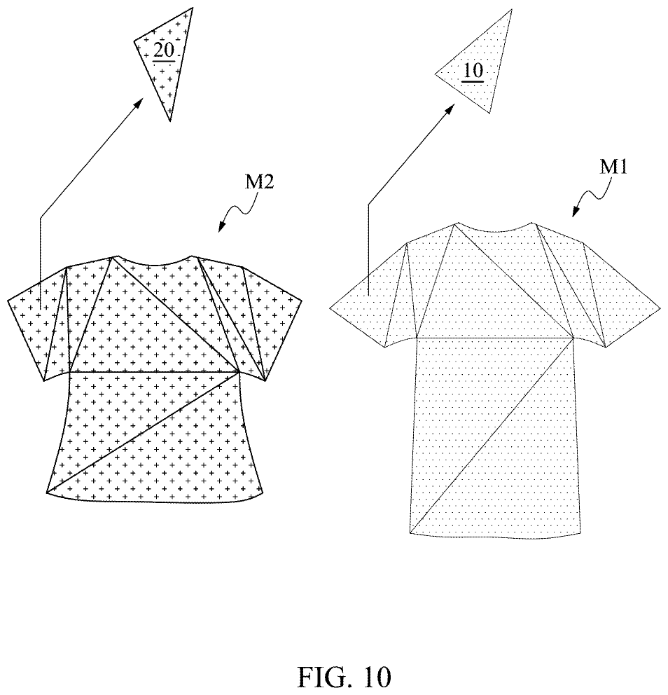

Reference is made to FIG. 10. FIG. 10 is a schematic diagram of the operation S262 in FIG. 3 according to some embodiments of the present disclosure. In the operation S262 in FIG. 3, the processor 140 takes out the first area 10 and the second area 20. As illustrated in FIG. 10, the processor 140 takes out the first area 10 from the planar model M1 of the mapped object OB1, and takes out the second area 20 from the planar model M2 of the mapping object OB2.

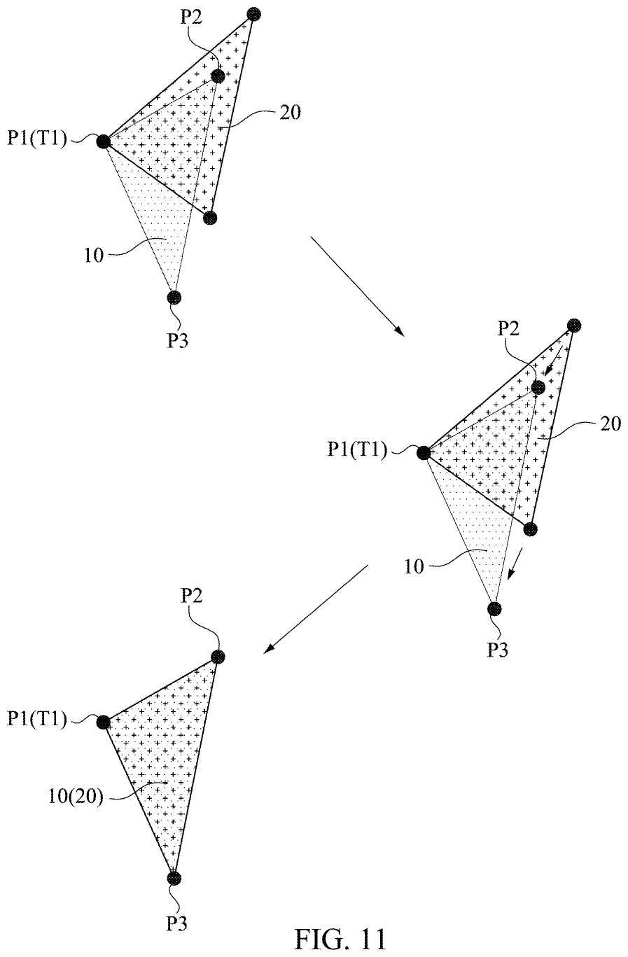

Reference is made to FIG. 11. FIG. 11 is a schematic diagram of the operations S264 and S266 in FIG. 3 according to some embodiments of the present disclosure. In the operation S264 in FIG. 3, the processor 140 puts the first area 10 and the second area 20 in the three-dimension environment. In the operation S266 in FIG. 3, the processor 140 performs an alignment process to the second area 20 based on the first area 10. As illustrated in FIG. 11, the processor 140 establishes an anchor point P1 at a corresponding position on the first area 10 based on an alignment apex T1 of the second area 20, and aligns the alignment apex T1 and the anchor point P1 in the three-dimension environment. Then, the processor 140 performs an adjustment process, such that other apexes and a plurality of sides of the second area 20 are aligned to anchor points P2, P3, and a plurality of sides of the first area 10 respectively. In some embodiments, the adjustment process includes a rotation process, a flip process, or a scale process. For example, the processor 140 aligns the apexes of the second area 20 to the anchor points P1-P3 respectively by Ray-cast technology, and aligns the sides of the second area 20 to the sides of the first area 10 respectively by a rotation process, a flip process, or/and a scale process.

Reference is made to FIG. 12. FIG. 12 is a schematic diagram of the operation S282 in FIG. 3 according to some embodiments of the present disclosure. In the operation S282 in FIG. 3, the processor 140 replaces the first area 10 by the adjusted second area 20 based on three-dimension coordinates in the three-dimension environment.

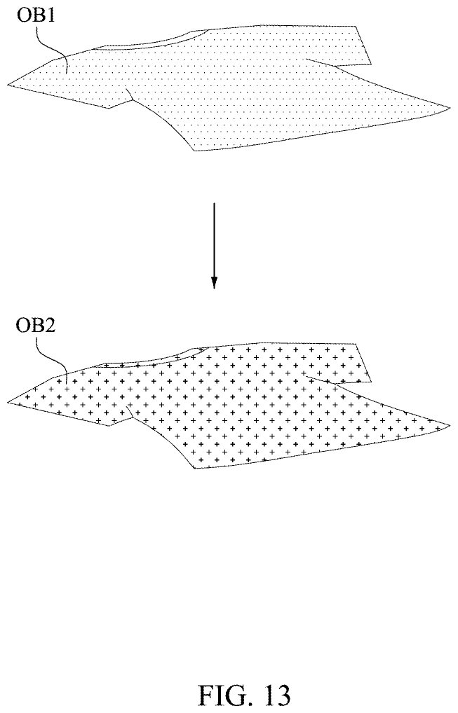

In the operation S284 in FIG. 3, the processor 140 executes the operation S262, the operation S264, the operation S266, and the operation S282 repeatedly, to process other areas. Accordingly, the first areas 10-19 can be replaced by the adjusted second areas 20-29 respectively in the three-dimension environment, to replace the mapped object OB1 by the mapping object OB2, as illustrated in FIG. 13. FIG. 13 is a schematic diagram of the mapped object OB1 is replaced by the mapping object OB2 according to some embodiments of the present disclosure.

Reference is made to FIG. 14. FIG. 14 is a schematic diagram of the operation S286 in FIG. 3 according to some embodiments of the present disclosure. In the operation S286 in FIG. 3, the processor 140 establishes the stereoscopic model SM of the mapping object OB2 in FIG. 8. As illustrated in FIG. 14, the processor 140 gets a two-dimension overlooking picture of the mapping object OB2 in the three-dimension environment according to an overlooking view. Then, the processor 140 transfers the two-dimension overlooking picture of the mapping object OB2 to the three-dimension environment to generate the stereoscopic model SM of the mapping object OB2.

The above description of the material replacement method 200 includes exemplary operations, but the operations of the material replacement method 200 are not necessarily performed in the order described. The order of the operations of the material replacement method 200 disclosed in the present disclosure are able to be changed, or the operations are able to be executed simultaneously or partially simultaneously as appropriate, in accordance with the spirit and scope of various embodiments of the present disclosure.

In some embodiments, the display device 160 in FIG. 1 displays the stereoscopic model SM. In some further embodiments, the stereoscopic model SM is displayed and applied to a virtual reality (VR), an augmented reality (AR), or a mixed reality (MR).

As described above, the material replacement method, the material replacement system, and the non-transitory computer readable storage medium of the present disclosure can reduce the deformation degree of the replacement result by performing a local processing to the mapping object.

Various functional components or blocks have been described herein. As will be appreciated by persons skilled in the art, in some embodiments, the functional blocks will preferably be implemented through circuits (either dedicated circuits, or general purpose circuits, which operate under the control of one or more processors and coded instructions), which will typically comprise transistors or other circuit elements that are configured in such a way as to control the operation of the circuitry in accordance with the functions and operations described herein. As will be further appreciated, the specific structure or interconnections of the circuit elements will typically be determined by a compiler, such as a register transfer language (RTL) compiler. RTL compilers operate upon scripts that closely resemble assembly language code, to compile the script into a form that is used for the layout or fabrication of the ultimate circuitry. Indeed, RTL is well known for its role and use in the facilitation of the design process of electronic and digital systems.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A material replacement method comprising:
generating, by a processor, a plurality of first areas according to a plurality of first feature points of a mapped object, to establish a first planar model corresponding to the mapped object;
generating, by the processor, a plurality of second areas according to a plurality of second feature points of a mapping object, to establish a second planar model corresponding to the mapping object;
respectively performing, by the processor, an alignment process to the second areas of the second planar model based on the first areas of the first planar model; and
respectively replacing, by the processor, the first areas by the adjusted second areas, to replace the mapped object by the mapping object and establish a stereoscopic model of the mapping object.

2. The material replacement method of claim 1, wherein the mapped object is corresponding to an original stereoscopic model and the mapping object is corresponding to a two-dimension picture.

3. The material replacement method of claim 1, wherein generating the plurality of first areas comprises:
based on a partition rule, connecting each N adjacent first feature points by the processor, to generate the plurality of first areas, wherein N is a positive integer equal to or greater than 3.

4. The material replacement method of claim 3, wherein generating the plurality of second areas comprises:
based on the partition rule, connecting each N adjacent second feature points by the processor, to generate the plurality of second areas, wherein a quantity and positions of the plurality of second areas are corresponding to a quantity and positions of the plurality of first areas.

5. The material replacement method of claim 4, wherein shapes of the plurality of first areas or shapes of the plurality of second areas are not all the same.

6. The material replacement method of claim 1, wherein performing the alignment process comprises:
based on an alignment apex of one of the plurality of second areas, establishing, by the processor, an anchor point on a corresponding one of the plurality of first areas;
aligning, by the processor, the alignment apex and the anchor point in a three-dimension environment; and
performing, by the processor, an adjustment process, such that a plurality of second sides of the one of the plurality of second areas are aligned to a plurality of first sides of the corresponding one of the plurality of first areas respectively.

7. The material replacement method of claim 6, wherein the adjustment process comprises a rotation process, a flip process, or a scale process.

8. The material replacement method of claim 1, further comprising:
setting, by the processor, shapes of the plurality of first areas or shapes of the plurality of second areas according to a setting command corresponding to an operation of a user.

9. The material replacement method of claim 1, wherein the stereoscopic model is displayed in a virtual reality (VR), an augmented reality (AR), or a mixed reality (MR).

10. A material replacement system comprising:
a memory configured to store one or more programs, wherein the one or more programs comprise instructions;
a processor configured to execute the instructions to execute following steps:
generating, by a processor, a plurality of first areas according to a plurality of first feature points of a mapped object, to establish a first planar model corresponding to the mapped object;
generating, by the processor, a plurality of second areas according to a plurality of second feature points of a mapping object, to establish a second planar model corresponding to the mapping object;
respectively performing, by the processor, an alignment process to the second areas of the second planar model based on the first areas of the first planar model; and
respectively replacing, by the processor, the first areas by the adjusted second areas, to replace the mapped object by the mapping object and establish a stereoscopic model of the mapping object; and
a display device configured to display the stereoscopic model.

11. The material replacement system of claim 10, wherein the mapped object is corresponding to an original stereoscopic model and the mapping object is corresponding to a two-dimension picture.

12. The material replacement system of claim 10, wherein the processor connects each N adjacent first feature points based on a partition rule, to generate the plurality of first areas, wherein N is a positive integer equal to or greater than 3.

13. The material replacement system of claim 12, wherein the processor connects each N adjacent second feature points based on the partition rule, to generate the plurality of second areas, wherein a quantity and positions of the plurality of second areas are corresponding to a quantity and positions of the plurality of first areas.

14. The material replacement system of claim 13, wherein shapes of the plurality of first areas or shapes of the plurality of second areas are not all the same.

15. The material replacement system of claim 10, wherein the processor establishes an anchor point on a corresponding one of the plurality of first areas based on an alignment apex of one of the plurality of second areas, aligns the alignment apex and the anchor point in a three-dimension environment, and performs an adjustment process, such that a plurality of second sides of the one of the plurality of second areas are aligned to a plurality of first sides of the corresponding one of the plurality of first areas respectively.

16. The material replacement system of claim 15, wherein the adjustment process comprises a rotation process, a flip process, or a scale process.

17. The material replacement system of claim 10, wherein the processor sets shapes of the plurality of first areas or shapes of the plurality of second areas according to a setting command corresponding to an operation of a user.

18. A non-transitory computer readable storage medium storing one or more programs, wherein the one or more programs comprise instructions and a processor is configured to execute the instructions, wherein when the processor executes the instructions, the processor executes following steps:
generating a plurality of first areas according to a plurality of first feature points of a mapped object, to establish a first planar model corresponding to the mapped object;
generating a plurality of second areas according to a plurality of second feature points of a mapping object, to establish a second planar model corresponding to the mapping object;
respectively performing an alignment process to the second areas of the second planar model based on the first areas of the first planar model; and
respectively replacing the first areas by the adjusted second areas, to replace the mapped object by the mapping object and establish a stereoscopic model of the mapping object.

19. The non-transitory computer readable storage medium of claim 18, wherein performing the alignment process comprises:
based on an alignment apex of one of the plurality of second areas, establishing an anchor point on a corresponding one of the plurality of first areas;
aligning the alignment apex and the anchor point in a three-dimension environment; and
performing an adjustment process, such that a plurality of second sides of the one of the plurality of second areas are aligned to a plurality of first sides of the corresponding one of the plurality of first areas respectively.

20. The non-transitory computer readable storage medium of claim 19, wherein the adjustment process comprises a rotation process, a flip process, or a scale process.
